(19) United States
(12) Patent Application Publication
(10) Pub. No.: US 2011/0211612 A1
(43) Pub. Date: Sep. 1, 2011

(54) TEMPERATURE SENSOR ARRAY AND METHOD OF ANALYZING A CONDITION OF WATER IN A TANK OF A WATER HEATING SYSTEM

(76) Inventor: Brian T. Branecky, Oconomowoc, WI (US)

(21) Appl. No.: 13/030,756

(22) Filed: Feb. 18, 2011

Related U.S. Application Data
(60) Provisional application No. 61/305,825, filed on Feb. 18, 2010.
(60) Provisional application No. 61/372,596, filed on Aug. 11, 2010.

(51) Int. Cl. G01K 3/00; G01N 25/00; G01K 13/00

(52) U.S. Cl. 374/115; 374/45; 374/137; 374/E03.001; 374/E13.001

(57) ABSTRACT

A system for determining a temperature of a medium, such as water, in a volume, such as a water heater tank. The system includes a temperature sensor array and a variable frequency voltage supply. A first temperature sensing unit of the temperature sensor array includes a temperature sensor in parallel with a capacitor. The capacitor is selected such that the impedance is low relative to the resistance of the temperature sensor at frequencies above a threshold and high at frequencies below a threshold. A second temperature sensing unit of the array includes a second temperature sensor. The temperatures sensed by the various temperature sensors in the array are determined by selectively varying the frequency of the voltage supply.

### RELATED APPLICATIONS

This application claims the benefit of co-pending U.S. Provisional Patent Application No. 61/305,825, filed on Feb. 18, 2010, and co-pending U.S. Provisional Patent Application No. 61/372,596, filed on Aug. 11, 2010, the content of each are hereby incorporated by reference.

### BACKGROUND

Water heaters, such as storage-type water heaters, are now manufactured with an increasing amount of diagnostic and communication capabilities. Home networks are bringing this information to the user through interactive devices that allow the homeowner to interact with the water heater.

### SUMMARY

Information that is desirable from a water heater includes the amount of hot water available, along with an estimated time to depletion based on the present rate of usage. If the temperature of water in the tank is uniform, then the calculation is straight forward. But in most installations and under high flows, the water temperature stratifies in the tank. In order to make an estimate of the amount of hot water available, in at least one embodiment, an array of temperatures is read at different points of the tank. Through the temperature array, an estimate of the amount of hot water available can be made. Other estimates, such as the amount of time remaining for hot water based on current use, can be made.

One embodiment of the invention includes a system for determining a temperature of a medium, such as water, as measured by each of a plurality of temperature sensors in a temperature sensor array. The system includes a variable frequency voltage supply, a controller, and a temperature sensor array. The temperature sensor array includes at least two temperature sensing units. The first temperature sensing unit includes a temperature sensor coupled to a first capacitor in a parallel-type relationship. The first capacitor has a low impedance (relative to the resistance of the temperature sensor) at frequencies above a first frequency threshold and a high impedance at frequencies lower than the threshold. The second temperature sensing unit is coupled to the first temperature sensing unit in series and includes a second temperature sensor. The controller selectively varies the frequency of the variable frequency voltage supply above and below the first threshold.

In one embodiment, the controller determines a temperature sensed by the second temperature sensor based on the voltage drop across the temperature sensor array when the variable frequency is set above the first frequency threshold. The controller determines the temperature sensed by the first temperature sensor by setting the frequency above the first frequency threshold and comparing the voltage drop when the frequency is above the threshold to the voltage drop when the frequency is below the threshold.

In some embodiments, one or more of the temperature sensing units includes a positive or negative facing diode coupled in a parallel-type relationship with the capacitor and the temperature sensor. In such embodiments, the temperature sensor is bypassed when the alternating current is either positive or negative depending upon the polarity of the diode.

Another embodiment includes a method of determining an amount of hot water in a water heater tank. The method includes determining a plurality of temperatures sensed by each temperature sensor in a temperature sensor array. The array includes a plurality of temperature sensor units and each temperature sensor unit includes a temperature sensor and a resonant circuit. The temperature sensor of each temperature sensor unit can be bypassed by adjusting the frequency of a variable frequency source that provides power to the temperature sensor array. The amount of hot water in the tank is then calculated based on the plurality of sensed temperatures.

In some embodiments, the temperatures are determined by varying the frequency of the variable frequency source. A first voltage drop of the temperature sensor array is measured at a first frequency and a second voltage drop is measured at a second frequency. In some embodiments, the temperature sensed by a first temperature sensor is determined based on the first voltage drop and a temperature sensed by a second temperature sensor is determined based on a difference between the first voltage drop and the second voltage drop.

In some embodiments, the method further determines a flow rate of hot water exiting the water heater tank and calculates a time remaining until the tank is empty based on the amount of hot water in the water heater tank and the flow rate. In some embodiments, the calculated time remaining is then displayed on a user interface.

An apparatus in accordance with one exemplary embodiment of the invention has a structure (e.g., a tank) filled at least partially with a fluid (e.g., water) and a temperature sensor array coupled to the structure. A second apparatus in accordance with another exemplary embodiment of the invention has the temperature sensor array being supported by a structure (e.g., a wall) within or defining a portion of a space (e.g., a room). A third apparatus in accordance with another exemplary embodiment of the invention is a temperature sensor array.

A first process in accordance with an exemplary embodiment of the invention is a method of controlling an apparatus (e.g., a water heater; a heating/cooling/ventilating system) using a temperature sensor array. A second process in accordance with an exemplary embodiment of the invention is a method of determining a plurality of temperatures at a plurality of locations, respectively, using a temperature sensor array.

Other aspects of the invention will become apparent by consideration of the detailed description and accompanying drawings.

### BRIEF DESCRIPTION OF THE DRAWINGS

FIG. 1 sectional view of a portion of a water heater.

FIG. 2 is a block diagram of a portion of a water temperature control system capable of controlling the water heater of FIG. 1.

FIG. 3 is a circuit schematic of an exemplary temperature sensor array for use in the water temperature control system of FIG. 2.

FIG. 4 is a circuit schematic of a second exemplary temperature sensor array for use in the water temperature control system of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description.

For illustrative purposes, embodiments of the invention will be discussed hereafter in the context of a storage-type water heater. However, the invention can be applied to other types of fluid dynamic systems. An HVAC system, for example, can be adapted to incorporate aspects of the invention.

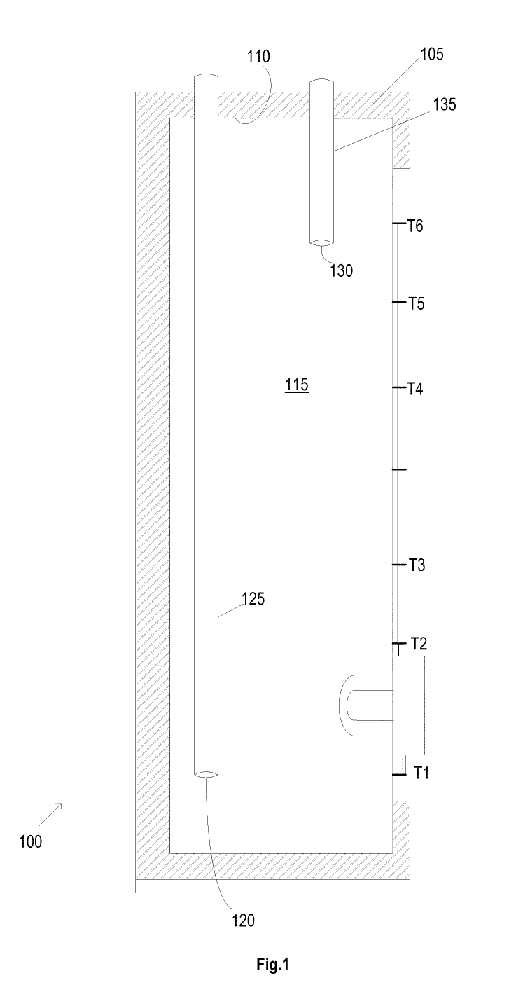

FIG. 1 depicts a storage-type water heater 100 comprising a structure (i.e., a tank 105 having a wall 110) defining a space 115 having a volume. The space 115 contains a fluid (i.e., water). Water enters the tank 105 via an inlet (i.e., an inlet 120 of a dip tube 125), and exits the tank 105 via an outlet (i.e., an outlet 130 of a dip tube 135). The water from the inlet tube 125 has a temperature different from the water in the space 115. Therefore, a temperature change occurs in the space 115 when water is introduced to the space 115. In some constructions of the invention, the depth of the outlet 130 of dip tube 135 may move to ensure that the outlet remains positioned within a volume of hot water within the tank.

In some constructions of the invention, waste water from a shower can be purified and returned to water tank through dip tube 125. Additionally, shampoo, lotion or other additives can be injected into water from the dip tube 135 before it is used in a shower.

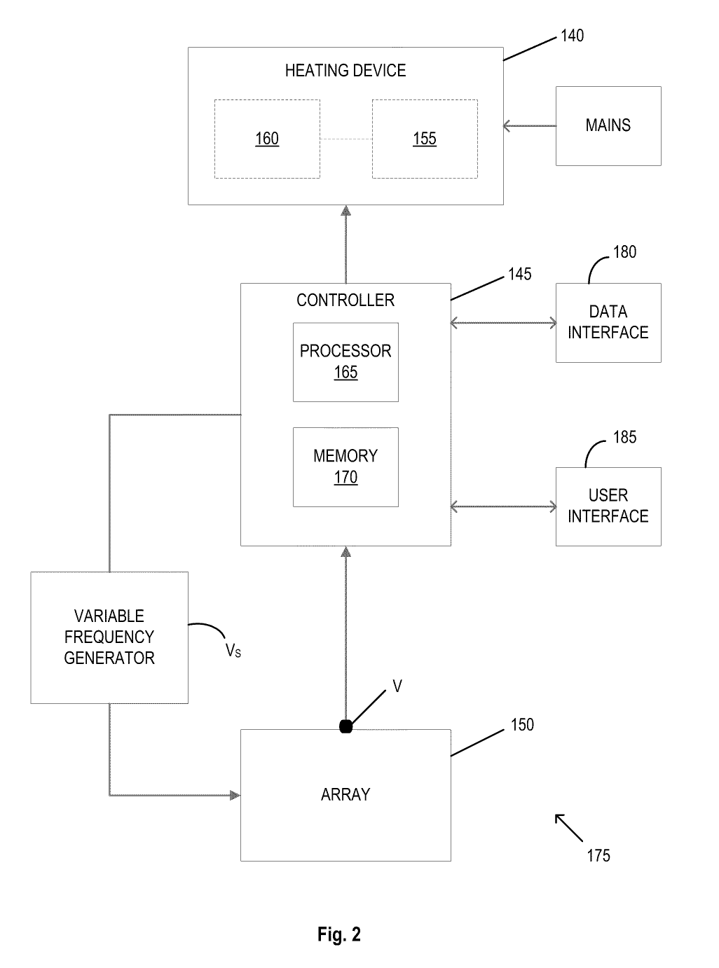

A heating device changes the thermal temperature of the fluid. In the case of the water heater, the heating device 140 (FIG. 2) heats the water in the storage tank 105. In the case of HVAC equipment, the heating device changes the thermal temperature of the fluid before it enters the space. The heating device 140 can comprise one of many types, including a gas burner, an electric resistance heating element, a refrigerant-based system, and a solar based system. Also, the heating device 140 can include multiple devices (e.g., a combination of distinct heating types or multiple like heating types). For example, the water heater 100 can include a combination electric resistance heating element and refrigerant-based system or can include multiple electric resistance heating elements.

The heating device 140 is selectively controlled by a controller 145 that activates and deactivates the heating device 140 based on a sensed temperature and, possibly, other information (e.g., use history, external commands, other sensed parameters, etc.). The sensed temperature is sensed by a temperature sensor. The sensed temperature can include or be based on multiple temperatures, as discussed below with a temperature sensor array 150. The sensed temperature, typically, has a correlation (or relation) to the temperature of the fluid in the space.

For example, if the temperature sensed by a temperature sensor falls below a first temperature threshold, referred to as a “lower set point” the controller 145 activates the heating device 140 such that it heats water within the tank 105. The heating device 140 remains activated until the temperature sensed by the temperature sensor exceeds a second temperature, referred to as an “upper set point.”

While one control scheme was just described above, various control schemes are contemplated for when the controller 145 activates the heating device 140 based on the sensed temperature and other information, if present, provided to the controller 145. Thus, the heating device 140 is repetitively activated and deactivated in an attempt to control the temperature sensed by the temperature sensor.

For a specific example with an electric-resistance storage-type water heater, the controller 145 controls a relay 155, which may be electro-magnetic, electronic, or a combination thereof. The relay is electrically connected between electrical mains and an electric-resistance heating element 160. The heating element 160 is a resistive device that generates heat when electrical current flows through the element 160. When the heating element 160 is to be activated, the controller 145 closes the relay 155 such that an electrical current from the electric mains passes through the heating element 160. When the heating element 160 is to be deactivated, the controller 145 opens the relay 155 such that no current flows in the heating element. Similarly, the controller 145 can control a valve for controlling the flow of gas for a burner, the refrigerant of a refrigeration system, or the fluid to be heated in a solar system. Also, the controller 145 may control other devices of the system (e.g., a pump or blower) depending on the type of apparatus and means for moving the fluid. For example, a circulation pump can be used to circulate the fluid within the tank so that an average temperature is achieved for all water within the tank at a given time.

The controller 145 includes control logic, which may be implemented in hardware, software, or a combination thereof. For example, the controller 145 can include a processor 165 and a memory 170. In one exemplary construction, the control logic includes software instructions stored in the memory 170, which may include other data. The software instructions are executed by the processor 165. One exemplary construction of the processor 165 includes at least one conventional processing element, such as a digital signal processor (DSP) or a central processing unit (CPU), that communicates to and drives the other elements within the temperature control system 175.

The controller 145 can include other elements known to skilled in the art, but not discussed herein. Exemplary elements include an analog-to-digital (A/D) converter, an I/O Interface, and a bus.

The temperature control system 175 includes a data interface 180 that enables the controller 145 to exchange information or commands with an external device (e.g., an external controller), and a user interface 185 that enables the controller to exchange information with a user. The user interface 185 may comprise user input devices, such as a keypad, buttons, or switches, which enable a user to input information to the controller 145. The user interface 185 may also comprise user output devices, such as a liquid crystal display (LCD) or other display device, light emitting diodes (LEDs), or other components known for outputting or conveying information to a user. The user input device and the user output device may be combined in a single device, such as a touch display.

It is also envisioned that the user interface 185 may be at another location remote from the control device. In one exemplary construction, a display device, such as a liquid crystal display (LCD), external to the controller 145 communicates with the controller 145 via the data interface 180. As an example, the display device may be mounted on a side of the tank 110. In other examples, the display device may be mounted elsewhere, such as in a bathroom. In still other devices, the controller 145 that evaluates the data from the temperature array 150 is separate from a main water heater controller that controls the operation of the heating element and the controllers are connected through a controller network.

As described above, the controller 145 selectively controls the activation states of the heating device 140 in an attempt to control the temperatures sensed by the temperature array 150. However, due to various factors, such as significant water usage within a relatively short duration, the heating device 145 may be unable to keep the temperature of the water within a desired range or at a desired value.

In one exemplary construction, the controller 145 is configured to automatically estimate the total amount of hot water currently in the tank 110 and to report this amount to a user. As used herein, “hot water” refers to water above a predefined temperature threshold, and “the total amount of hot water currently in the tank 110” refers to the total amount of water currently in the tank 110 above the predefined temperature threshold.

Further, the water within the tank 110 often is not at a uniform temperature such that water in different areas of the tank 110 often has significantly different temperatures. This process is referred to as stratification. Further, the temperature profile of the water in the tank 110 can vary over time as water usage changes. Indeed, as water is drawn from the tank 110 and replenished, convection currents in the tank 110 can disrupt the current temperature profile. The temperature readings of the temperature sensors T1-T6 (FIG. 1) provide real-time relational temperature information about the water in close proximity of the sensors T1-T6.

The estimated amount of hot water in the tank 110 can be expressed in a variety of ways. In one example, the controller 145 may report that a number of gallons (or liters) of hot water is currently in the tank 110, where the number is from zero to the total volume capacity of the tank 110 depending on the temperature characteristics of the water in the tank 110. In another implementation, the estimated amount of hot water may be expressed as a percentage of the overall volume capacity of the tank 100. As a specific example, if the total capacity of the tank 110 is forty gallons and if the controller 145 determines that the total amount of hot water currently in the tank 110 is twenty gallons, then the controller 145 may report that the tank 110 is fifty percent full of hot water. Various other techniques for expressing the estimated amount of hot water in the tank 110 are possible, including by graphical and animated means. Further, based on the temperature profile over time or through the use of a flowmeter, the controller 145 can predict when the water heater 100 runs out of hot water.

It is also envisioned that the temperature sensor array 150 can be used to track hot water usage. For a simple example, if the controller 145 determines the amount of hot water available in the tank 110 or the temperature profile of the tank 110 over time, the controller 145 can estimate the amount of hot water used. The controller 145 can use this information to develop a history of usage for the water heater 110, predict future usage of the water heater 110, and develop predictive algorithms to heat the water.

Various methodologies may be employed to estimate the total amount of hot water currently in the tank 110. In one exemplary implementation, the controller 145 estimates the total amount of hot water currently in the tank 110 based on the readings of the temperature sensors T1-T6. Further information can be used to estimate the total amount of hot water currently in the tank, such as the size or dimensions of the tank 110.

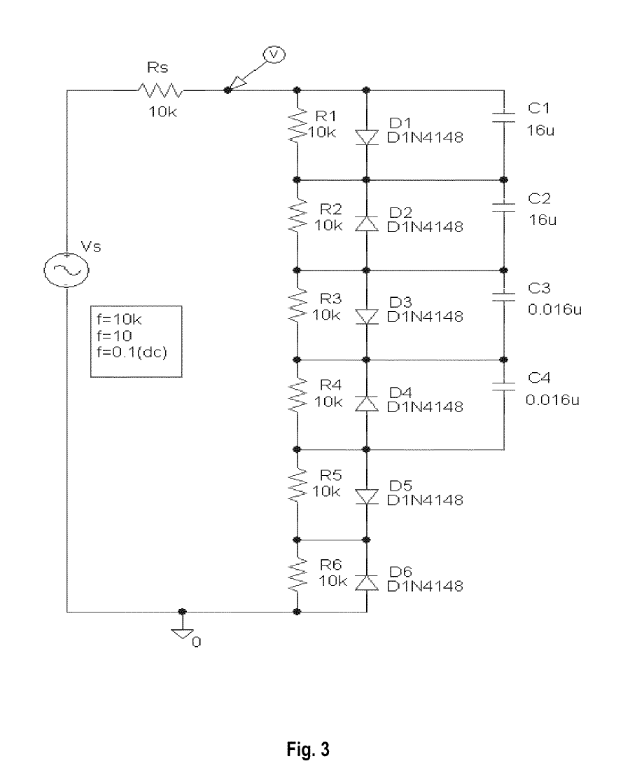

One temperature sensor array 150 that can be used with the invention is the temperature sensor array 150 shown in FIG. 3. In this construction, the sensors T1-T6 include Negative Temperature Coefficient, NTC, thermistors in an array. The sensors T1-T6 are schematically shown in FIG. 3 as resistors R1-R6, respectively, connected in a series relationship. Capacitors C1-C4 and diodes D1-D6 are connected in a parallel relationship with each resistor R1-R4, respectively and resistors R1-R6, respectively. The capacitors C1-C4 and diodes D1-D6 help select the temperature sensor T1-T6 being sensed by the polarity and frequency of the signal generated by variable frequency generator Vs. An exemplary variable frequency generator Vs is a pulse width modulated (PWM) sine wave generator or a filtered square wave.

For a specific example, when the source, Vs, is 10 khz and 10 volts, the impedance of capacitors C1-C4 are considered small as compared to resistors R1-R4. The voltage measured at node V when Vs is positive will be the voltage across R6 due to the diode D5 shorting R5. From the measured voltage, the resistance of R6 can be determined. The resistance of resistor R6 has a relation to the temperature sensed by the thermistor T6, and the sensed temperature has a relation to the fluid near the thermistor T6. When Vs is negative, diode D6 shorts resistor R6, the voltage measured at node V is the voltage across resistor R5. From the measured voltage, the resistance of R5 can be determined. The resistance of resistor R5 has a relation to the temperature sensed by the thermistor T5, and the sensed temperature has a relation to the fluid near the thermistor T5.

Continuing the specific example, when the source, Vs, is 10 hz and 10 volts, the impedance of capacitors C1, C2 are considered small as compared to resistors R1, R2. The voltage measured at node V when Vs is positive will be the voltage across resistors R6, R4 due to diodes D5, D3 shorting resistors R5, R3. From the measured voltage, the resistance of resistor R4 can be determined from the previous knowledge of resistor R6. The resistance of resistor R4 has a relation to the temperature sensed by the thermistor T4, and the sensed temperature has a relation to the fluid near the thermistor T4. When Vs is negative, diodes D6, D4 short resistors R6, R4, and the measured voltage at node V is the voltage across resistors R5, R3. From the measured voltage, the resistance of resistor R3 can be determined from the previous knowledge of resistor R5. The resistance of resistor R3 has a relation to the temperature sensed by the thermistor T3, and the sensed temperature has a relation to the fluid near the thermistor T3.

Continuing further with the specific example, when the source, Vs, is 0.1 hz (or a direct current (DC) source), 10 volts, and positive, diodes D5, D3, D1 short resistors R5, R3, and R1. The voltage measured at node V is the voltage across resistors R6, R4, R2. From the measured voltage, the resistance of resistor R2 can be determined from the previous knowledge of resistors R6, R4. The resistance of resistor R2 has a relation to the temperature sensed by the thermistor T2, and the sensed temperature has a relation to the fluid near the thermistor T2. When Vs is negative, diodes D6, D4, D2 short resistors R6, R4, R2, and the measured voltage at node V is the voltage across resistors R5, R3, R1. From the measured voltage, the resistance of resistor R1 can be determined from the previous knowledge of resistors R5, R3. The resistance of resistor R1 has a relation to the temperature sensed by the thermistor T1, and the sensed temperature has a relation to the fluid near the thermistor T1.

In other constructions, additional circuit elements can be included in each temperature sensing unit. In FIG. 3, resistor R1, diode D1, and capacitor C1 are coupled in parallel to form a single temperature sensing unit. However, in alternative constructions, additional circuit elements may be coupled in series with the resistor R1, diode D1, or capacitor C1 in the first temperature sensing unit. For example, an additional resistive element may be included in series with resistor R1. In such a construction, the resistors R1 would remain in a parallel-type relationship with diode D1 and capacitor C1 even though the additional resistive element is added in series with only the resistor R1.

Furthermore, although the example above describes a variable frequency voltage supply, other constructions of the invention may utilize other variable frequency power supplies designed to operate various types of resonant circuits.

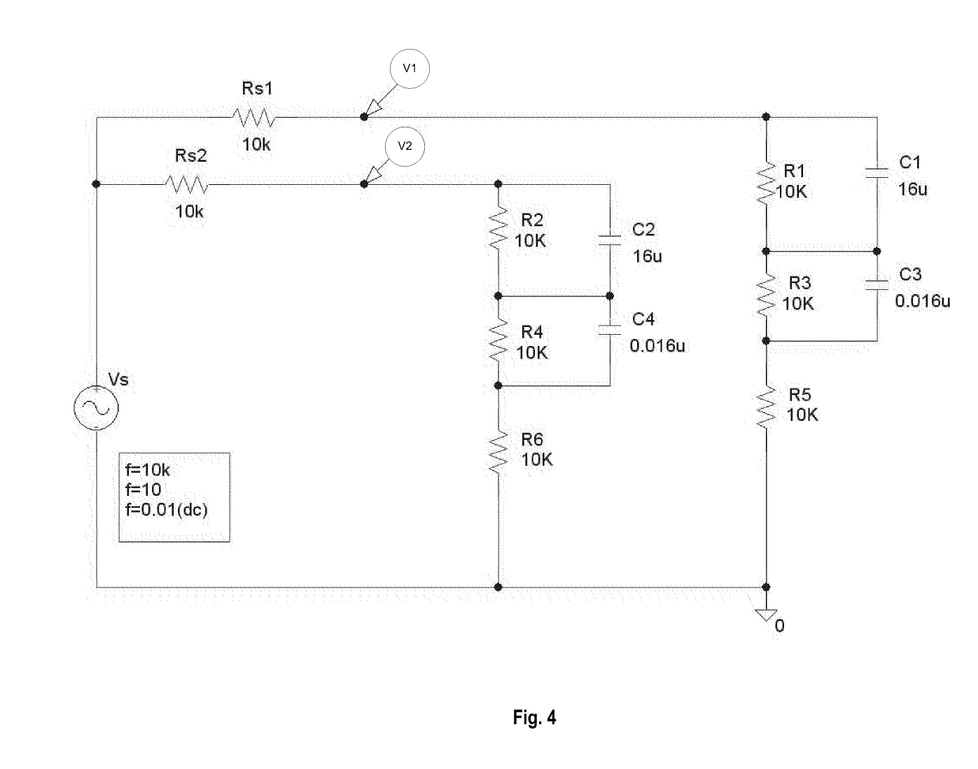

An alternative temperature sensor array 150 that can be used with the invention is the temperature sensor array 150 shown in FIG. 4. In this construction, the sensors T1-T6 include Negative Temperature Coefficient, NTC, thermistors in an array. The sensors T1-T6 are schematically shown in FIG. 4 as resistors R1-R6, with R1, R3, and R5 connected in a first series relationship, and R2, R4, and R6 connected in a second series relationship. Capacitors C1-C4 are connected in a parallel relationship with each resistor R1-R4, respectively. The capacitors C1-C4 help select the temperature sensor T1-T6 being sensed by the frequency of the signal generated by variable frequency generator Vs. An exemplary variable frequency generator Vs is a pulse width modulated (PWM) sine wave generator or a filtered square wave.

For a specific example, when the source, Vs, is 10 khz and 10 volts, the impedance of capacitors C1-C4 are considered small as compared to resistors R1-R4. The voltage measured at node V1 will be the voltage across R5. From the measured voltage, the resistance of R5 can be determined. The resistance of resistor R5 has a relation to the temperature sensed by the thermistor T5, and the sensed temperature has a relation to the fluid near the thermistor T5. The voltage measured at node V2 will be the voltage across R6. From the measured voltage, the resistance of R6 can be determined. The resistance of resistor R6 has a relation to the temperature sensed by the thermistor T6, and the sensed temperature has a relation to the fluid near the thermistor T6.

Continuing the specific example, when the source, Vs, is 10 hz and 10 volts, the impedance of capacitors C1, C2 are considered small as compared to resistors R1, R2. The voltage measured at node V1 will be the voltage across resistors R3 and R5. From the measured voltage, the resistance of resistor R3 can be determined from the previous knowledge of resistor R5. The resistance of resistor R3 has a relation to the temperature sensed by the thermistor T3, and the sensed temperature has a relation to the fluid near the thermistor T3. The voltage measured at node V2 will be the voltage across resistors R4 and R6. From the measured voltage, the resistance of resistor R4 can be determined from the previous knowledge of resistor R6. The resistance of resistor R4 has a relation to the temperature sensed by the thermistor T4, and the sensed temperature has a relation to the fluid near the thermistor T4.

Continuing further with the specific example, when the source, Vs, is 0.1 hz (or a direct current (DC) source), 10 volts, and positive, the voltage measured at node V1 is the voltage across resistors R1, R3, and R5. From the measured voltage, the resistance of resistor R1 can be determined from the previous knowledge of resistors R3 and R5. The resistance of resistor R1 has a relation to the temperature sensed by the thermistor T1, and the sensed temperature has a relation to the fluid near the thermistor T1. The voltage measured at node V2 is the voltage across resistors R2, R4, and R6. From the measured voltage, the resistance of resistor R2 can be determined from the previous knowledge of resistors R4 and R6. The resistance of resistor R2 has a relation to the temperature sensed by the thermistor T2, and the sensed temperature has a relation to the fluid near the thermistor T2.

In one arrangement, each temperature sensor T1-T6 would be equally spaced from the top to the bottom of the tank on the inside of the tank 110. For example, the temperatures sensors T1-T6 can be mounted on the inside wall of the tank 110 or on the dip tube 125. With this arrangement, the determined resistances of resistors R1-R6 have a direct relationship to the fluid temperature surrounding the respective temperature sensors T1-T6. In another arrangement, each temperature sensor T1-T6 would be equally spaced from the top to the bottom of the tank 110 on the outside of the tank 110. The temperature sensors T1-T6 are mounted to the tank and are thermally connected to the tank 110. With this arrangement, the determined resistances of resistors R1-R6 have an indirect relationship to the fluid near the respective temperature sensors T1-T6.

In another construction, the temperature sensors T1-T6 can be added to an existing water heater tank by replacing the existing dip tube 125 with a dip tube that includes sensors T1-T6 installed along the length of the replacement dip tube.

It is also envisioned that the temperature sensors T1-T6 could be unequally spaced. The temperature of the fluid near the bottom of the tank is typically uniform. Therefore, the density of the sensors T1-T6 may increase as the temperature sensor array progresses from the bottom of the tank toward the top of the tank.

Furthermore, although the system described above uses only the temperature sensor array 150 to determine the amount of hot water in the tank, other construction of the invention may use other methods in lieu of or in addition to the temperature sensor array 150 to determine the amount of hot water in the tank. These methods may include, for example, sonar configured to bounce at the interface between cold and hot water, a refrigerant filled copper tube that detects pressure changes caused by varying temperatures, a laser diopler or floating balls to determine the depth of the hot water, painting the tank with resistive ink to monitor changes in temperature, and load sensing positioned under the tank to detect changes in mass due to varying temperatures of a consistent volume of water.

Thus, the invention provides, among other things, a new and useful temperature sensor array, an apparatus including the temperature sensor array, and a method of obtaining a plurality of temperatures using the temperature sensor array.

Various features and advantages of the invention are set forth in the following claims.

What is claimed is:

1. A system for determining a temperature of a medium as measured by each of a plurality of temperature sensors in a temperature sensor array, the system comprising:
a variable frequency voltage supply;
a temperature sensor array including
a first temperature sensing unit, the first temperature sensing unit including a first temperature sensor coupled in a parallel-type relationship with a first capacitor,
the first capacitor having a low impedance relative to a resistance of the first temperature sensor when a variable frequency from the variable frequency voltage supply is greater than a first frequency threshold and a high impedance relative to the resistance of the first temperature sensor when the variable frequency is lower than the first frequency threshold, and
a second temperature sensing unit coupled in series with the first temperature sensing unit relative to the variable frequency voltage supply, the second temperature sensing unit including a second temperature sensor; and
a controller that selectively varies the variable frequency of the variable frequency voltage supply between a first frequency that is higher than the first frequency threshold and a second frequency that is lower than the first frequency threshold, and determines a temperature sensed by the first temperature sensor and a temperature sensed by the second temperature sensor based on a voltage drop of the temperature sensor array.

2. The system of claim 1 wherein the controller determines the temperature sensed by the second temperature sensor by
setting the variable frequency to the first frequency and
determining a first voltage drop of the temperature sensor array when the variable frequency is set to the first frequency.

3. The system of claim 2, wherein the controller determines the temperature sensed by the second temperature sensor by changing the variable frequency from the first frequency to the second frequency, determining a second voltage drop of the temperature sensor array when the variable frequency is set to the second frequency, and comparing the first voltage drop to the second voltage drop.

4. The system of claim 1, wherein the temperature sensor array further includes
a third temperature sensing unit positioned in series with the first temperature sensing unit relative to the variable frequency voltage supply,
the third temperature sensing unit including a third temperature sensor, a first positive diode, and a second capacitor coupled in a parallel-type relationship,
the second capacitor having a low impedance relative to a resistance of the first temperature sensor when a variable frequency from the variable frequency voltage supply is greater than a first frequency threshold and a high impedance relative to the resistance of the first temperature sensor when the variable frequency is lower than the first frequency threshold, and
a fourth temperature sensing unit coupled in series with the first temperature sensing unit relative to the variable frequency voltage supply, and including a fourth temperature sensor and a second positive diode coupled in a parallel-type relationship,
wherein the first temperature sensing unit further includes a first negative diode coupled in a parallel-type relationship with the first temperature sensor and the first capacitor, and
wherein the second temperature sensing unit further includes a second negative diode couple in a parallel-type relationship with the second temperature sensor.

5. The system of claim 4, wherein the controller
determines the temperature sensed by the second temperature sensor by setting the variable frequency to the first frequency and determining a first voltage drop of the temperature sensor array when the variable frequency is set to the first frequency and a voltage generated by the variable frequency voltage supply is negative,
determines a temperature sensed by the fourth temperature sensor by determining a second voltage drop of the temperature sensor array when the variable frequency is set to the first frequency and the voltage generated by the variable frequency voltage supply is positive,
determines the temperature sensed by the first temperature sensor by setting the variable frequency to the second frequency, determining a third voltage drop of the temperature sensor array when the variable frequency is set to the second frequency and the voltage generated by the variable frequency voltage supply is negative, and comparing the first voltage drop to the third voltage drop, and
determines a temperature sensed by the third temperature sensor by determining a fourth voltage drop of the temperature sensor array when the variable frequency is set to the second frequency and the voltage generated by the variable frequency voltage supply is positive, and comparing the second voltage drop to the fourth voltage drop.

6. The system of claim 1, wherein the temperature sensor array further includes a third temperature sensing unit, the third temperature sensing unit coupled in series with the first temperature sensing unit relative to the variable frequency voltage supply, the third temperature sensing unit including a third temperature sensor coupled in a parallel-type relationship with a second capacitor, the second capacitor having a low impedance relative to the resistance of the third temperature sensor when the variable frequency is greater than a second frequency threshold and a high impedance relative to the resistance of the third temperature sensor when the variable frequency is lower than the second frequency threshold, the second frequency threshold being lower than the first frequency threshold.

7. The system of claim 6, wherein the controller
determines the temperature sensed by the second temperature sensor by setting the variable frequency to the first frequency and determining a first voltage drop of the temperature sensor array when the variable frequency is set to the first frequency,
determines the temperature sensed by the first temperature sensor by setting the variable frequency to the second frequency, determining a second voltage drop of the temperature sensor array when the variable frequency is set to the second frequency, and comparing the first voltage drop to the second voltage drop, and
determines a temperature sensed by the third temperature sensor by setting the variable frequency to a third frequency, determining a third voltage drop of the temperature sensor array when the variable frequency is set to the third frequency, and comparing the first voltage drop and the second voltage drop to the third voltage drop,
wherein the second frequency is lower than the first frequency threshold and higher than the second frequency threshold, and wherein the third frequency is lower than the second frequency threshold.

8. The system of claim 1, wherein the voltage drop of the temperature sensor array is the voltage drop across the temperature sensor array.

9. A water heating system including a tank and the system of claim 1, wherein the first temperature sensor is positioned to sensed a temperature of water in the tank at a first location and the second temperature sensor is positioned to sense a temperature of water in the tank at a second location.

10. The water heating system of claim 9, wherein the controller determines an amount of water in the tank that is above a first temperature threshold based on the temperature sensed by the first temperature sensor and the temperature sensed by the second temperature sensor.

11. The water heating system of claim 9, wherein the controller determines an average temperature of water in the tank based on the temperature sensed by the first temperature sensor and the temperature sensed by the second temperature sensor.

12. A water heating system, comprising:
a tank;
a variable frequency voltage supply;
a temperature sensor array including a plurality of temperature sensing units coupled in series relative to the variable frequency voltage supply, the plurality of temperature sensing units including
a first temperature sensing unit including a first temperature sensor, a first positive diode, and a first capacitor coupled in a parallel-type relationship, the first capacitor having a low impedance relative to a resistance of the first temperature sensor when a variable frequency from the variable frequency voltage supply is greater than a first frequency threshold and a high impedance relative to the resistance of the first temperature sensor when the variable frequency is lower than the first frequency threshold,
a second temperature sensing unit including a second temperature sensor, a first negative diode, and a second capacitor coupled in a parallel-type relationship, the second capacitor having a low impedance relative to a resistance of the second temperature sensor when the variable frequency is greater than the first frequency threshold and a high impedance relative to the resistance of the second temperature sensor when the variable frequency is lower than the first frequency threshold,
a third temperature sensing unit including a third temperature sensor, a second positive diode, and a third capacitor coupled in a parallel-type relationship, the third capacitor having a low impedance relative to a resistance of the third temperature sensor when the variable frequency is greater than a second frequency threshold and a high impedance relative to the resistance of the third temperature sensor when the variable frequency is lower than the second frequency threshold,
a fourth temperature sensing unit including a fourth temperature sensor, a second negative diode, and a fourth capacitor coupled in a parallel-type relationship, the fourth capacitor having a low impedance relative to a resistance of the fourth temperature sensor when the variable frequency is greater than the second frequency threshold and a high impedance relative to the resistance of the fourth temperature sensor when the variable frequency is lower than the second frequency threshold,
a fifth temperature sensing unit including a fifth temperature sensor coupled in a parallel-type relationship with a positive diode, and
a sixth temperature sensing unit including a sixth temperature sensor coupled in a parallel-type relationship with a negative diode; and
a controller that determines a temperature sensed by each of the plurality of temperature sensing units by
setting the variable frequency of the variable frequency voltage supply to a first frequency that is higher than the first frequency threshold and higher than the second frequency threshold,
determining the temperature sensed by the sixth temperature sensor by determining a first voltage drop of the temperature sensor array when the variable frequency is set to the first frequency and a voltage generated by the variable frequency voltage supply is negative,
determining the temperature sensed by the fifth temperature sensor by determining a second voltage drop of the temperature sensor array when the variable frequency is set to the first frequency and the voltage generated by the variable frequency voltage supply is positive,
setting the variable frequency of the variable frequency voltage supply to a second frequency that is higher than the first frequency threshold, and lower than the second frequency threshold,
determining the temperature sensed by the fourth temperature sensor by determining a third voltage drop of the temperature sensor array when the variable frequency is set to the second frequency and the voltage generated by the variable frequency voltage supply is negative, and subtracting the first voltage drop from the third voltage drop,
determining the temperature sensed by the third temperature sensor by determining a fourth voltage drop of the temperature sensor array when the variable frequency is set to the second frequency and the voltage generated by the variable frequency voltage supply is positive, and subtracting the second voltage drop from the fourth voltage drop,
setting the variable frequency of the variable frequency voltage supply to a third frequency that is lower than the first frequency threshold and lower than the second frequency threshold,
determining the temperature sensed by the second temperature sensor by determining a fifth voltage drop of the temperature sensor array when the variable frequency is set to the third frequency and the voltage generated by the variable frequency voltage supply is negative, and subtracting the first voltage drop and the third voltage drop from the fifth voltage drop, and
determining the temperature sensed by the first temperature sensor by determining a sixth voltage drop of the temperature sensor array when the variable frequency is set to the third frequency and the voltage generated by the variable frequency voltage supply is positive, and subtracting the second voltage drop and the fourth voltage drop from the sixth voltage drop.

13. The water heating system of claim 12, wherein the controller determines an amount of water in the tank that is above a first temperature threshold based on the temperature sensed by each of the plurality of temperature sensing units.

14. The water heating system of claim 12, wherein the controller determines an average temperature of water in the tank based on the temperature sensed by each of the plurality of temperature sensing units.

15. A method of determining an amount of hot water in a water heater tank, comprising:
determining a plurality of temperatures sensed by each temperature sensor of a temperature sensor array, the temperature sensor array including a plurality of temperature sensor units, each temperature sensor unit including a temperature sensor and a resonant circuit, wherein the temperature sensor of each temperature sensor unit can be bypassed by adjusting the frequency of a variable frequency source that provides power to the temperature sensor array; and
calculating an amount of water in the water heater tank that is above a temperature threshold based on the plurality of sensed temperatures.

16. The method of claim 15, wherein the act of determining a plurality of temperatures includes
setting the frequency of the variable frequency source to a first variable frequency;
measuring a first voltage drop of the temperature sensor array when the frequency is set to the first variable frequency;
setting the frequency of the variable frequency source to a second variable frequency; and
measuring a second voltage drop of the temperature sensor array when the frequency is set to the first variable frequency.

17. The method of claim 16, wherein the act of determining a plurality of temperatures further includes
determining a temperature sensed by a first temperature sensor based on the first voltage drop; and
determining a temperature sensed by a second temperature sensor based on a difference between the first voltage drop and the second voltage drop.

18. The method of claim 15, further comprising:
determining a flow rate of hot water exiting the water heater tank;
calculating a time remaining until the tank is empty based on the amount of hot water in the water heater tank and the flow rate; and
displaying the time remaining on a user interface.
